(19) United States
(12) Patent Application Publication
(10) Pub. No.: US 2026/0136254 A1
(43) Pub. Date: May 14, 2026

(54) FEDERATED CLOUD-BASED MULTI-SIM MANAGEMENT FOR MOBILE ROUTERS

(71) Applicant: Cisco Technology, Inc., San Jose, CA (US)

(72) Inventors: Jerome Henry, Pittsboro, NC (US); Nikhil Mathur, Santa Clara, CA (US); Robert Edgar Barton, Richmond (CA); Lakshmi Thiyagarajan, Palo Alto, CA (US); Stanley Huang, San Jose, CA (US); Ashok Hegde, Bangalore (IN)

(21) Appl. No.: 18/941,184

(22) Filed: Nov. 8, 2024

(51) Int. Cl. H04W 36/14; H04W 8/20; H04W 36/00; H04W 36/32

(52) U.S. Cl. CPC H04W 36/14; H04W 8/20; H04W 36/0058; H04W 36/322

(57) ABSTRACT

Disclosed are systems, apparatuses, methods, and computer-readable media for preventing supervision frame injection attacks in replication networks. A method includes: identifying, by a network device, a trusted network device in a replication network; providing credentials to the trusted network device to validate an identity of the network device; based on authentication of the credential at the trusted network device, receiving security information from the trusted network device that is encrypted with a public key of the network device; and transmitting an onboarding supervision frame encrypted with or signed by the security information, wherein a management device of the replication network updates a trusted peer information based on the onboarding supervision frame.

### TECHNICAL FIELD

The disclosure relates generally to cloud networking and, more specifically but not exclusively, to systems and techniques for federated cloud-based multi-SIM management for mobile routers.

### BACKGROUND

The Internet of Things (IoT) involves a network of devices equipped with sensors and software that communicate data over the internet, providing benefits like real-time insights and automation across various sectors, including transportation. In public transit, IoT enables real-time tracking, predictive maintenance, and improved passenger safety. However, deploying IoT in public transit vehicles faces significant challenges, particularly due to unreliable network connections, which can disrupt data transmission, degrade IoT device lifespan, and require costly and complex infrastructure. The inconsistency in network coverage, especially with cellular gateways, remains a critical problem that hinders optimal IoT operations along transit routes.

### BRIEF DESCRIPTION OF THE DRAWINGS

In order to describe the manner in which the above-recited and other advantages and features of the disclosure may be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates a diagram of an example cloud computing architecture used for Internet of Things (IoT) infrastructure;

FIG. 2 illustrates a diagram of an example fog computing architecture that may be deployed as aspects of an IoT infrastructure;

FIG. 3 is a conceptual diagram of an example IoT system for federated cloud-based multi-sim management for mobile routers in accordance with some aspects of the disclosure in accordance with some aspects of the disclosure;

FIG. 4 is a sequence diagram 400 of an IoT service that uses a machine learning (ML) model for federated cloud-based multi-sim management in accordance with some aspects of the disclosure;

FIG. 5 is a map 500 illustrating navigation of a public transit vehicle in a municipality and different operations that can occur based on federated cloud-based multi-SIM management for mobile routers in accordance with some aspects of the disclosure;

FIG. 6 illustrates a map of an IoT router and measurements recorded along a route recorded by the IoT router in accordance with some aspects of the disclosure;

FIG. 7 illustrates an example method for federated cloud-based multi-SIM management at an IoT backend in accordance with some aspects of the disclosure;

FIG. 8 illustrates an example method for federated cloud-based multi-SIM management at an IoT router in accordance with some aspects of the disclosure; and

FIG. 9 shows an example of a computing system, which may be for example any computing device that may implement components of the system.

### DESCRIPTION

### Overview

Aspects of the present disclosure are directed to federated cloud-based multi-subscriber identification module (SIM) management for mobile routers. More specifically, techniques described herein relate to dynamically controlling IoT devices to switch between different network operators or mobile network operators (MNOs) for various reasons. An example method includes receiving, from an IoT device attached to a vehicle, a message at an infrastructure data service, the message including location of the IoT device and an active carrier of the network device. In this case, the IoT device may be configured with multiple SIMs and can switch between different MNOs. The infrastructure data service is connected to the first network and the second network for SIM management, obtains information from an ML model to switch the active carrier of the network device based at least on the location and the active carrier, and the provides an instruction to the network device to switch the active carrier. In this case, the systems and techniques may cause an IoT device to handover to a different MNO based on degradation of communication capacity in a particular region. The IoT backend may control these operations based on measurements received from the IoT devices and data provided to the IoT backend via an interface to an MNO. The systems and techniques may deploy an ML model to facilitate decisions based on measurement data across varying conditions.

### Example Embodiments

The Internet of Things (IoT) refers to the network of interconnected devices embedded with sensors, software, and other technologies to collect and exchange data over the internet. This network includes everything from household devices (e.g., refrigerators, thermostats, etc.), industrial machines, and city infrastructure. IoT devices gather data from their environment and communicate this data to other devices or systems, and act based on the information received. These devices can monitor various parameters, such as temperature, humidity, motion, and more, providing real-time insights and automation capabilities. IoT enhances efficiency, convenience, and safety across various sectors, including healthcare, transportation, manufacturing, and smart homes, by enabling predictive maintenance, optimizing resource use, and improving decision-making processes.

IoT has particular applications in vehicles and may be used to create new efficiencies, increase safety, and add new functionality. In public transit vehicles such as buses, trains, and trams, IoT enables real-time tracking and monitoring to provide precise arrival and departure time. Sensors and connectivity in IoT devices in vehicles can identify potential issues before potential breakdowns to ensure reliability and reduce downtime, as well as efficiently scheduling predictive maintenance. IoT systems also enhance passenger safety through surveillance and automated emergency response features. Additionally, data collected from public transit vehicles helps optimize routes, manage traffic flow, and improve fuel efficiency. Passengers benefit from up-to-date travel information and seamless integration with other modes of transportation, making public transit more accessible and convenient.

A major concern in deployment of IoT devices in public transit vehicles is the reliability of network connections. For example, vehicles often travel through areas with poor or no signal coverage and cause disruptions in data transmission. IoT devices can also generate a significant volume of data, and disruptions in wireless connectivity can create issues with data transmission and degrade the lifespan of the IoT device. For example, a non-volatile memory is limited to a number of read/write cycles, and the IoT device may need to store data in non-volatile memory when a network connection degrades due to the limited memory within the IoT device. Additionally, the vast amount of data generated by IoT devices requires robust and secure infrastructure to handle storage, processing, and real-time analysis, which can be both costly and complex to implement.

One primary use for IoT gateway deployment is intelligent and dynamic routing, particularly with respect to public transit vehicles and other public vehicles (e.g., emergency vehicles, municipal services, etc.). Most IoT gateways are over cellular wide area network (WAN) links such as 4G/5G, and a control center manages deployed IoT services and data services. A major impediment to deploying cellular gateways is inconsistent network coverage for optimal operations along the routes. Conventional tools for mapping cellular services use a path traversal vehicle that collects cellular received signal strength and plots the received signal strength on maps based on GPS coordinates to create a heat map. In some cases, complex calibration tools are also deployed to profile cellular signals at fine-grained level and transmit the detailed measurements to the control center. Transmitting cellular signal strength at fine-grained frequency along with GPS data consumes a heavy amount of bandwidth.

Systems, apparatuses, processes (also referred to as methods), and computer-readable media (collectively referred to as “systems and techniques”) are described herein for federated cloud-based multi-subscriber identification module (SIM) management for mobile routers. In some aspects, the systems and techniques relate to dynamically controlling IoT devices to switch between different network operators or mobile network operators (MNOs) for various reasons. For example, the systems and techniques may cause an IoT device to handover to a different MNO based on degradation of communication capacity in a particular region. In this case, the IoT device may be configured with multiple SIMs and can switch between different MNOs. The IoT backend may control these operations based on measurements received from the IoT devices and data provided to the IoT backend via an interface to an MNO. The systems and techniques may deploy an ML model to facilitate decisions based on measurement data across varying conditions.

An example method includes receiving, from a network device attached to a vehicle, a message at an infrastructure data service, the message including location of the network device and an active carrier of the network device, wherein the network device includes a first SIM for a first network corresponding to the active carrier and a second SIM for a second network, wherein the infrastructure data service is connected to the first network and the second network for SIM management; obtaining information from an ML model to switch the active carrier of the network device from a first communication link associated with a first carrier to a second communication link associated with the second carrier based at least on the location and the active carrier; and providing an instruction to the network device to switch the active carrier to the second carrier.

Various aspects of the application will be described with respect to the figures.

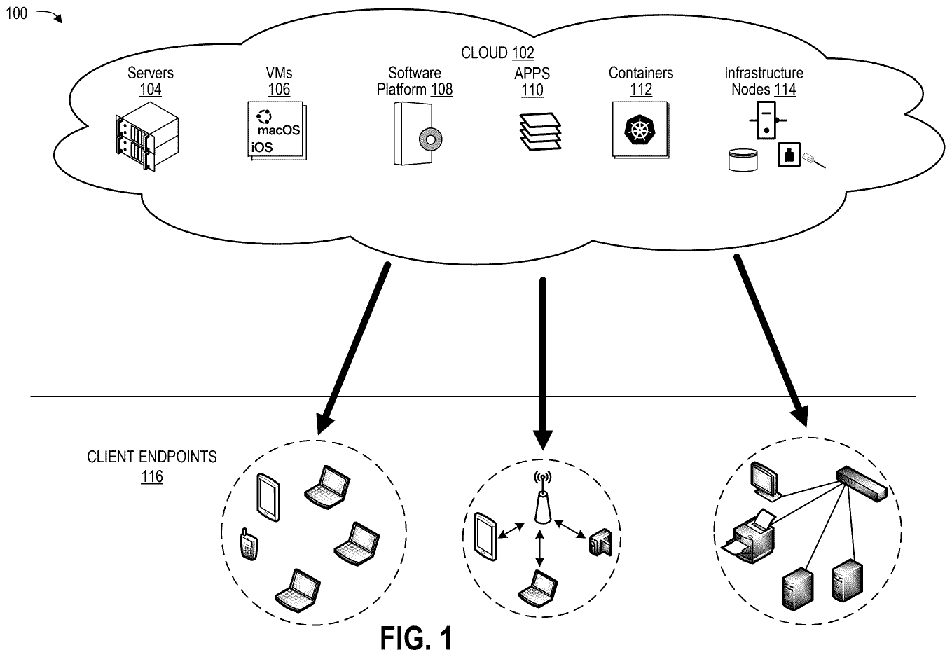

FIG. 1 illustrates a diagram of an example cloud computing architecture 100. The architecture can include a cloud 102. The cloud 102 can be used to form part of a TCP connection or otherwise be accessed through the TCP connection. Specifically, the cloud 102 can include an initiator or a receiver of a TCP connection and be utilized by the initiator or the receiver to transmit and/or receive data through the TCP connection. The cloud 102 can include one or more private clouds, public clouds, and/or hybrid clouds. Moreover, the cloud 102 can include cloud elements that provide different types of functionality. The cloud elements can include, for example, servers 104, virtual machines (VMs) such as VMs 106, one or more software platforms 108, applications or services 110, software containers 112 (e.g., Kubernetes), and infrastructure nodes 114. The infrastructure nodes 114 can include various types of nodes, such as compute nodes, storage nodes, network nodes, management systems, databases, authentication services, and other distributed functions.

The cloud 102 can be used to provide various cloud computing services via the cloud elements, such as SaaSs (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with the cloud elements via one or more public networks (e.g., Internet), private networks, and/or hybrid networks (e.g., virtual private networks). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., a networked refrigerator, a networked lighting system, etc.), a city or transportation system (e.g., traffic control, toll collection system, etc.), an internet of things (IoT) device, a camera, a network printer, a transportation system (e.g., train, motorcycle, boat, etc.), or any smart or connected object (e.g., smart home, smart building, smart retail, smart glasses, etc.), and so forth.

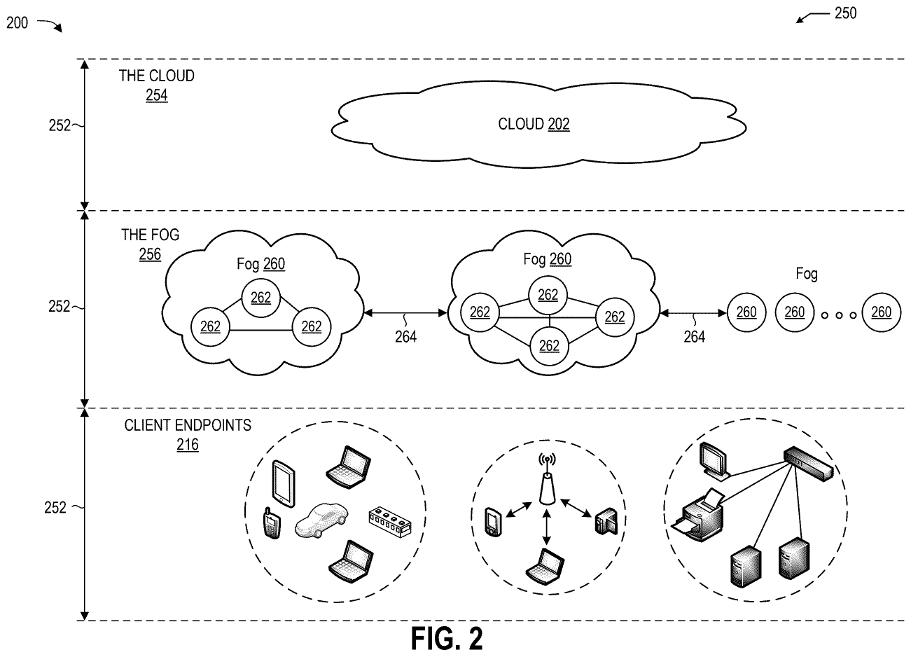

FIG. 2 illustrates a diagram 200 of an example fog computing architecture 250. The fog computing architecture can be used to form part of a TCP connection or otherwise be accessed through the TCP connection. Cloud infrastructure uses a centralized topology with different data centers connected with high bandwidth backhaul networks and advanced storage systems to replicate data between data centers. Fog architecture uses edge devices to carry out a substantial amount of computation, storage, and communication locally and routed over a distributed network.

In some aspects, the fog computing architecture can include an initiator or a receiver of a TCP connection and be utilized by the initiator or the receiver to transmit and/or receive data through the TCP connection. The fog computing architecture 250 can include the cloud layer 254, which includes the cloud 202 and any other cloud system or environment, and the fog layer 256, which includes fog nodes 262. The client endpoints 216 can communicate with the cloud layer 254 and/or the fog layer 256. The fog computing architecture 250 can include one or more communication links 252 between the cloud layer 254, the fog layer 256, and the client endpoints 216. Communications can flow up to the cloud layer 254 and/or down to the client endpoints 216.

The fog layer 256 or “the fog” provides the computation, storage and networking capabilities of traditional cloud networks, but closer to the endpoints. The fog extends the cloud 202 to be closer to the client endpoints 216 and can be the physical implementation of fog networks. Moreover, the fog nodes 262 can provide local or regional services and/or connectivity to the client endpoints 216. As a result, traffic and/or data can be offloaded from the cloud 202 to the fog layer 256 (e.g., via fog nodes 262). The fog layer 256 can thus provide faster services and/or connectivity to the client endpoints 216, with lower latency, as well as other advantages such as security benefits from keeping the data inside the local or regional networks.

The fog nodes 262 can include any networked computing devices, such as servers, switches, routers, controllers, cameras, access points, gateways, etc. Moreover, the fog nodes 262 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes such as fog nodes 262 can be deployed within a fog instance 260. A fog instance 260 can be local or regional clouds or networks. For example, a fog instances 260 can be a regional cloud or data center, a local area network, a network of fog nodes 262, etc. In some configurations, one or more of fog nodes 262 can be deployed within a network, or as standalone or individual nodes, for example. Moreover, one or more of the fog nodes 262 can be interconnected with each other via links 264 in various topologies, including star, ring, mesh or hierarchical arrangements, for example.

In some cases, one or more of fog nodes 262 can be mobile fog nodes. The mobile fog nodes can move to different geographic locations, logical locations or networks, and/or fog instances while maintaining connectivity with the cloud layer 254 and/or the client endpoints 216. For example, a particular fog node can be placed in a vehicle, such as an aircraft or train, which can travel from one geographic location and/or logical location to a different geographic location and/or logical location. In this example, the particular fog node may connect to a particular physical and/or logical connection point with the cloud 202 while located at the starting location and switch to a different physical and/or logical connection point with the cloud 202 while located at the destination location. The particular fog node can thus move within particular clouds and/or fog instances and, therefore, serve endpoints from different locations at different times.

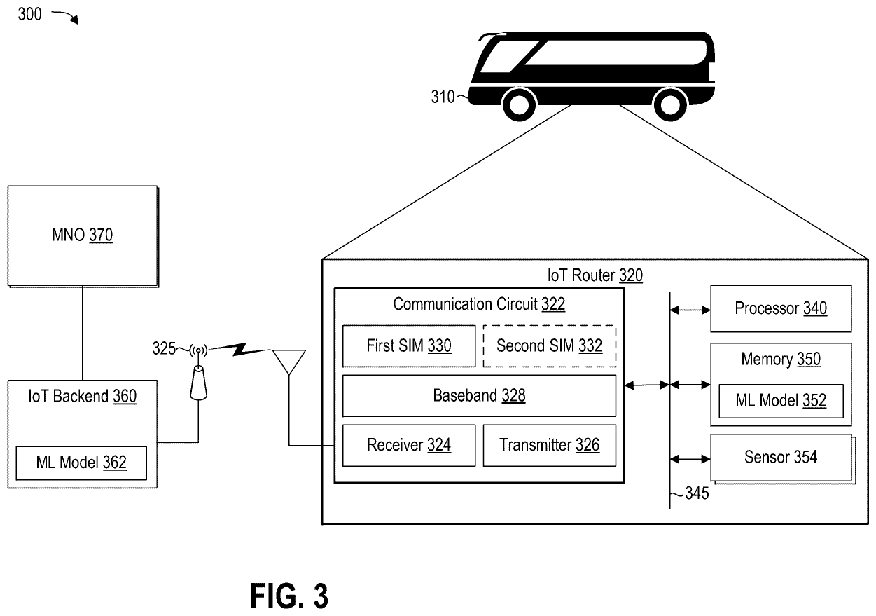

FIG. 3 is a conceptual diagram of an example IoT system 300 in accordance with some aspects of the disclosure. The IoT system 300 includes a vehicle 310 including an IoT router 320 that is configured to connect to an access point 325 and communicate data with an IoT backend 360. In some aspects, the IoT backend 360 manages data collection, processing, and analysis from connected devices to surface various services and additional functionality to the infrastructure, as well as functions for the general public. For example, the IoT router 320 of the vehicle 310 may serve as a WiFi access point for passengers. The IoT backend 360 includes a plurality of services, devices, and servers for implementing complex services. For example, the IoT backend 360 can be deployed in a fog architecture or a cloud network, and may use local infrastructure. The IoT backend 360 includes modern architecture such as using containers (e.g., docker containers, Kubernetes services) to deploy dynamic services.

The IoT router 320 may include a communication circuit 322 (e.g., a communication module) including at least one receiver 324 and at least one transmitter 326 for bidirectional communication. For example, the communication circuit 322 can connect to various wireless services such as 3G/4G/5G. The communication circuit 322 can also include a baseband processor 328 (e.g., a modulator, demodulator, etc.). In one illustrative aspect, the communication circuit 322 can include multiple subscriber identity modules (SIMs) such as a first SIM 330 and a second SIM 332 for enabling wireless connections to various MNOs 370. The IoT router 320 also includes a processor 340, a communication bus 345 for connecting various components of the IoT router 320, a memory 350, and at least one sensor such as sensor 354.

In some aspects, the memory 350 may store an ML model 352 and provide weights to the processor 340 for inferring information based on the information detected by sensor 354. For example, the sensor 354 is configured to detect geographical location (e.g., using GPS) and the processor 340 in conjunction with the ML model 352 may determine to autonomously handover to a different MNO 370. Various aspects of the ML model 352 are further described below.

The IoT router 320 is configured to connect to an IoT backend 360 via a wireless interface (e.g., 3G/4G/5G, etc.) in connection with providing various services. For example, the IoT router 320 includes an antenna configured to send and receive information to the IoT backend 360 via an access point 325 associated with an MNO 370. Although not illustrated, the access point 325 can be various types of network access points such as a femto base station, a macro base station which has a larger transmit power, and so forth. The IoT router 320 can send sensor data from the sensor 354 and other information to the IoT backend 360 to provide data services for passengers or data pertaining to the vehicle 310 (e.g., signal strengths, interference, traffic conditions, passenger conditions, etc.). For example, the IoT router 320 can send location data to the IoT backend 360 for data analysis purposes.

In some aspects, the IoT backend 360 is configured to analyze data provided by the IoT router 320 to configure services of the IoT router 320 and other IoT devices within a fleet of vehicles and other various nodes (e.g., an access point of a transit pickup location). In some examples, the IoT backend 360 may include an ML model 362 to perform various real-time services to assist with fleet management, fleet monitoring, and other services.

In one aspect, the ML model 362 is configured to control the IoT router 320 based on sensor data provided by the IoT router 320 and based on destination information or other state information of the IoT router 320. For example, the IoT router 320 may provide location data from the sensor 354 and destination information associated with the vehicle 310 (e.g., a next stop of the vehicle 310). The IoT backend 360 may provide the data to the ML model 362 to predict various decisions of the IoT router 320 and the vehicle 310. For example, the ML model 362 can instruct the IoT router 320 to switch between different MNOs 370 to prevent signal degradation. In another case, the IoT backend 360 may also be configured to receive sensor data and other metrics from other IoT nodes (e.g., vehicles, fixed network nodes associated with traffic infrastructure, sensors, etc.). The ML model 362 can predict traffic congestion and provide suitable directions to a destination, as well as identify corresponding network conditions. For example, the ML model 362 may be configured to receive and store data as a time series and provide complex inferences based on a combination of patterns that are not discernable with manual processes. As an example, network conditions may rapidly deteriorate based on congestion at a particular chokepoint. The ML model 362 can identify these patterns and infer how to handle network decisions in the event of unusual events based on real-time information from the IoT router 320.

The IoT backend 360 is also configured to interface with at least one MNO 370 using an interface. For example, the IoT backend 360 is connected to an API of different MNOs 370 and can surface information from each MNO 370. For example, the IoT backend 360 may query each MNO 370 for data usage associated with an account (e.g., corresponding to the first SIM 330). In this case, the IoT backend 360 can determine that, based on information from the different MNO 370, the IoT router 320 should change to a different MNO based on data consumption of that account (e.g., a billing event may occur because data consumption may exceed a maximum data transfer threshold). In other cases, information provided from the different MNO 370 can be used in inference of the ML model 362. As an example, the different MNO 370 may surface information pertaining to base station availability to balance network usage, and the ML model 362 may use this information to assess and control the IoT router 320. In the event that the IoT backend 360 receives network performance information from MNO 370 (e.g., latency, capacity, interference, etc.), the IoT backend 360 may determine that a different MNO should be used for network access and may instruct the IoT router 320 to switch MNOs. The IoT router 320 may then deactivate the first SIM 330 and activate the second SIM 332 and connect to the different MNO. To allow seamless handover, the IoT router 320 can provide a seamless transition to the next MNO by preventing new connections once instructions are received to switch MNO and draining existing connections.

In some aspects, the IoT backend 360 is configured to make network operation decisions for a multi-SIM router (e.g., the IoT router 320) based on an ML model 362 and various aspects. For example, the IoT backend 360 may determine that a quality of service associated with an MNO may not support a particular application used by the IoT router 320. For example, a public safety vehicle (e.g., the vehicle 310) may be monitoring a real-time video feed and requires high bandwidth and low latency. The IoT backend 360 may have a connection into the MNO 370 via an API to retrieve information pertinent to operation of the IoT router 320 and other devices within the IoT system. For example, the IoT backend 360 may connect to the MNO 370 and retrieve billing cycle information (e.g., a volume of network data consumed during a monthly billing cycle). In other cases, the IoT backend 360 can also retrieve information that the different MNO 370 makes available, such as network status of corresponding access points (e.g., access point 325) within a geographical area.

The IoT system 300 may use various types of ML models, such as a transformer, a convolutional neural network (CNN) or a recurrent neural network (RNN). A transformer is a neural network architecture built into natural language processing (NLP) tasks, such as language translation, sentiment analysis, and text summarization. Conventional traditional recurrent neural networks (RNNs) process data in sequence, which slows the operations and training. A transformer or transformer network can process input in parallel and is faster and more efficient than sequential training and processing. In some aspects, transformers use a self-attention mechanism, which allows a transformer to identify the most relevant parts of the input text or content (e.g., audio or video). In some cases, transformers can also use a cross-attention mechanism which uses other content or data to determine the most relevant parts of the input. For example, cross-attention mechanisms are useful in sequential content such as a stream of data, such as optical flow, and other computer vision techniques.

In one example, the ML model 352 may be deemed a small model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task (e.g., in the vehicle 310). Small generative models can also be easier to train and interpret, making them suitable for certain applications. For example, ChatGPT-3.5 has 175 billion parameters and would result in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

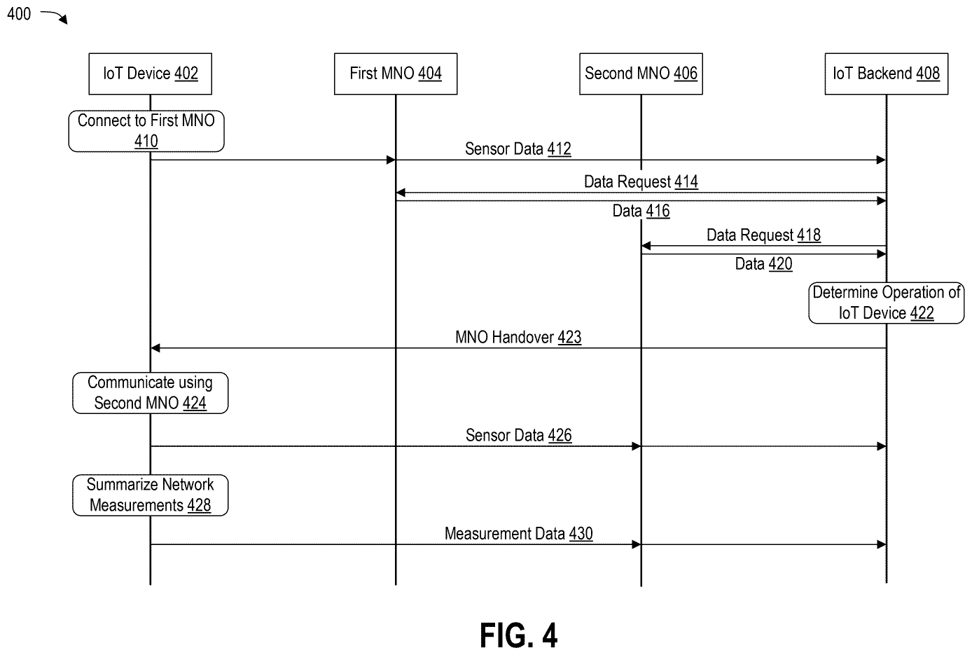

FIG. 4 is a sequence diagram 400 of an IoT service that uses an ML model for federated cloud-based multi-SIM management in accordance with some aspects of the disclosure. For example, an IoT device 402 may include a plurality of SIMs and can connect to a first MNO 404 and a second MNO 406 as part of communicating with an IoT backend 408. The IoT backend 408 may be connected to first MNO 404 and the second MNO 406 (e.g., as shown in FIG. 3) via an interface such as an API or a remote procedure call (RPC) mechanism.

At block 410, the IoT device 402 is configured to connect to the first MNO 404. For example, the IoT device 402 connects via a 4G wireless communication network. Once the network connection and authentication with the IoT backend 408 is successfully performed, the IoT device 402 may send sensor data 412 to the IoT backend 408. For example, the IoT device 402 may send sensor data 412 to an access point (not shown) of the first MNO 404, which is then provided to the IoT backend 408.

The IoT device 402 may send sensor data 412 includes sensor data such as geographical location data (e.g., GPS data). The sensor data can also include movement information, such as the speed (or acceleration) of a vehicle associated that the IoT device 402 is affixed. In some cases, the IoT device 402 may send sensor data 412 can also send other information pertinent to the state of the IoT device 402, such as a next hop for a public transit vehicle or a destination for a public safety vehicle.

The IoT backend 408 may need to provide decisions to the IoT device 402 based on dynamic conditions. For example, the IoT backend 408 may need to determine the quality of network communication between a current location and a destination and determine whether the IoT device 402 should handover to a different MNO based on the signal quality, network capacity, and other metrics. For example, the IoT backend 408 may include an ML model (not shown) that is trained to identify potential network communication issues in dynamic real-time conditions. For example, the quality of network signals and capacity can be dynamic based on traffic conditions, environmental conditions (e.g., humidity), as well as season (e.g., leaves can absorb RF energy and reduce signal strength based on season).

In this case, the IoT backend 408 may send a data request 414 to the first MNO 404, which returns the requested data 416. The IoT backend 408 may also send a data request 418 to a second MNO 406, which returns the requested data 420 to the IoT backend 408.

In some aspects, at block 422, the IoT backend 408 may determine various operations of the IoT device. For example, the IoT backend 408 may determine sub-optimal network communication associated with a path based on dynamic conditions. The IoT backend 408 may check network consumption information that can be surfaced to the IoT device 402 to provide custom information to the IoT device 402 to facilitate ideal network conditions. As an example, large events (e.g., professional sporting events) can create challenging network conditions, and the MNO may surface information to external customers to assist in balancing network communications by surfacing capacity information associated with base stations, or other network infrastructure. In this case, the IoT backend 408 may instruct a public transit vehicle with an IoT device 402 to use communication infrastructure (e.g., a base station) that is farther from the large event.

In other aspects, the IoT backend 408 may be configured to optimize network communication based on an application being executed by the IoT device 402. For example, if the IoT device 402 requires a real-time video feed, the IoT backend 408 determines the best network based on QoS, latency, jitter, network type, and other metrics that may be more suitable. The IoT backend 408 may also be configured to optimize network billing operations based on services plans of the IoT backend 408 to prevent any data overage fees. As an example, the IoT backend 408 may request billing cycle information of the MNOs via an interface (e.g., an API, etc.) on a backend network connection. The IoT backend 408 may determine, based on a combination of the current network usage, to prioritize a particular MNO to optimize data usage and reduce network usage costs. In this way, the IoT backend 408 can use a combination of billing cycle information, communication quality, transit vehicle routes, time, and other detected information to dynamically perform network selection from the IoT device 402.

In one illustrative aspect, the IoT backend 408 may determine that, based on a destination of the IoT device 402, the IoT device 402 should switch from the first MNO 404 to the second MNO 406. In that case, the IoT backend 408 may provide a handover command 423 to the IoT device 402, which then performs the necessary operations to connect to the second MNO 406 at block 424. For example, the IoT device 402 can be a multi-SIM device and can dynamically select the MNO based on instructions from the IoT backend 408. The IoT device 402 can then continue to connect to the IoT backend 408 and send sensor data 426 via the second MNO 406 to ensure that the IoT backend 408 remains in contact with the IoT device 402 despite dynamic network conditions.

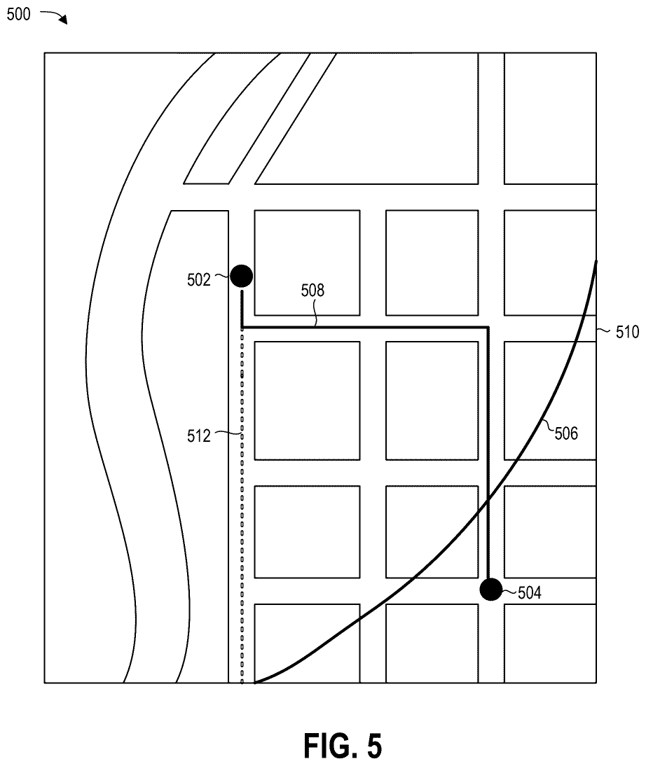

In some aspects, the IoT device 402 may also collect measurements from different access points of MNOs (e.g., the first MNO 404, the second MNO 406, etc.) to map signal metrics from the various MNOs to profile wireless coverage in connection with the IoT backend 408. For example, the IoT device 402 may monitor and evaluate signal strength of the access points (e.g., the access point 325 in FIG. 5) of the first MNO 404 and the second MNO 406. For example, the IoT device 402 can build time series data with each data point identifying a geographical location, a trajectory, and a velocity of the IoT device 402 along with signal metrics (e.g., received signal strength) associated with signals. In some cases, the IoT device 402 may monitor paging channels to allow the IoT device 402 to monitor signals of other MNOs and channel performance across a spectrum.

As the IoT device 402 moves, the IoT device 402 records the signal metrics that the IoT device 402, summarizes the signal metrics at block 428, and then reports data corresponding to signal coverage to the IoT backend 408. For example, the IoT device 402 may dynamically create virtual geofences corresponding to poor coverage and may report the geofence data 430 instead of heavier data sets such as location data and received signal information (e.g., frequency, signal strength, etc.). A geofence can be represented by a center point (e.g., a location of the IoT device 402) and a radius (e.g., a radius), and the radius may be inversely correlated to an error rate that indicates chances of success of communication. In this case, the IoT device 402 can provide reports to the IoT backend 408 in a manner that minimizes bandwidth but provides pertinent information.

In the case that the IoT device 402 is attached to a public transit vehicle that is scheduled to navigate a specific router, the IoT device 402 can record the route multiple times and clean the data during measurement. For example, the IoT device 402 may attempt to record data at the same point on different iterations of the route to build confidence in the network measurements. In some iterations of the route, the IoT device 402 may also attempt to measure at interpolation intervals between data points. For example, in the case of heavy traffic conditions, the IoT device 402 may provide elect to perform measurements at specific points between existing data points within the time series. The IoT device 402 provides initial cleaning of the data based on multiple correlated measurements with datapoints selected that can improve interpolation accuracy. In this way, the IoT backend 408 can use the data to refine signal metrics that are measured in a highly correlated manner and an ML model (e.g., the ML model 352 or the ML model 362) can be trained for runtime operation.

FIG. 5 is a map 500 illustrating navigation of a public transit vehicle in a municipality and different operations that can occur based on federated cloud-based multi-SIM management for mobile routers in accordance with some aspects of the disclosure.

In some aspects, the map 500 illustrates the potential path of a vehicle from a current location 502 to a destination location 504. The vehicle includes an IoT router with a multi-SIM capabilities. The IoT router can be provided instructions from an IoT backend (e.g., the IoT backend 408 in FIG. 4) to switch SIMs based on various conditions, usage, and so forth. In one example, the vehicle may report a current location 502 and various information such as a trajectory, a velocity, and other sensed information of the vehicle to an IoT backend (e.g., a control center such as the IoT backend 408 in FIG. 4). In this case, the report may include a destination location 504, such as a next stop associated with a public transit vehicle. The report may also include a conventional route 508 that identifies a path the vehicle is expected to traverse to the destination location 504.

The IoT backend may determine that a boundary region 506 associated with an MNO may be crossed. For example, an ML model can infer that the signal quality at the destination location 504 may deteriorate and not support wireless connections. In this case, the IoT backend or the ML model can determine a condition for the vehicle to switch to a different MNO. For example, if the vehicle maintains the conventional route 508 by turning onto street 510, the condition may be satisfied and cause the IoT router to initiate inter-MNO handover. For example, the IoT backend determines that when the vehicle crosses the boundary region 506, communication capacity may be diminished based on cellular coverage by a first MNO. Accordingly, by causing the IoT router to initiate handover before approaching the boundary region 506, cellular connection of the IoT router attached to the vehicle can be maintained.

On the other hand, if the IoT router continues to traverse path 512 and does not turn onto street 510, the condition of the IoT router may not be satisfied and the IoT can request further instructions from the IoT backend. For example, the IoT router (or the IoT backend) may determine that no passenger has requested dropoff or pickup at the destination location 504. In that case, the IoT backend may provide instructions (or the IoT router may determine) to traverse along path 512 without requiring an inter-MNO handover based on not crossing not into the boundary region 506.

In some aspects, the inter-MNO handover decisions may be predicated on other factors, such as QoS necessary to support a specific application, bandwidth consumption of an MNO based on billing cycle, network information surfaced by the MNO from the infrastructure plane (e.g., via an API interface, etc.), and so forth.

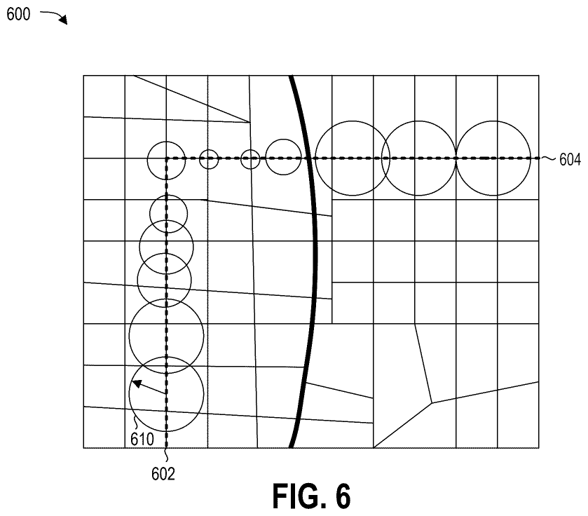

FIG. 6 illustrates a map of an IoT router and measurements recorded along a route recorded by the IoT router in accordance with some aspects of the disclosure. For example, the IoT router can be affixed to a public transit vehicle such as a bus to record signal measurements and aggregate measurements based on multiple measurements over multiple traversals of the route. The IoT can also be affixed to other vehicles such as public safety vehicles, and taxis, to dynamically coordinate resources and infrastructure.

In the illustrated aspect, the IoT router can measure signal strengths of MNOs while in transit along a predetermined route prepared by a planner or other system for dynamically assigning routes. For example, map 600 illustrates an ingress point 602 of the vehicle including the IoT router and an egress point 604. The IoT router captures multiple measurements of signal strengths of at least one MNO along the route and generates a plurality of geofences representing signal strength of an MNO. For example, geofence 610 illustrates a geofence having a center point and a radius, with the radius corresponding to a signal strength. In one case, the signal strength may be associated with an inverse of a bit error rate to normalize measurements based on quality of reception. For example, the geofences represent a likelihood of data reception error, which may more accurately reflect issues such as QoS, jitter, etc.

The IoT router may traverse the route multiple times in a day and may capture additional metadata that can be used to improve map functions. For example, the signals are not static and can change based on environmental conditions such as weather, humidity, and so forth. In this way, the IoT router can generate geofences that accurately reflect the signal strengths as they change across short intervals of time and long intervals of time. In some cases, the IoT router can also be configured to repeat measurements with high correlation based on previous iterations of the router. For example, on a second traversal of a route, the IoT device may ensure that opportunities for ideal matching measurements (e.g., stopped at a specific intersection) are captured. In this way, the geofences may be provided to the IoT backend in a clean format without requiring significant bandwidth since location (e.g., center point) and radius are light data as compared to frequencies, signal strengths, and so forth.

The data provided by the IoT router can be combined with backend data from the IoT backend. For example, the IoT backend may be in communication with an MNO based on network conditions, billing cycle information, and so forth. The IoT backend may capture this information and store this data as time series data. By storing data as a time series, network data from the MNO can be combined with IoT router measurements (e.g., via interpolation to normalize the data) to infer network performance, cost, and other metrics. For example, an IoT backend may use the data to determine that a particular area of a map may have significant network delays at a particular time of day due to traffic congestion. Accordingly, the IoT backend can instruct an IoT router to switch to a different MNO when congestion and communication quality are degraded along a route in that particular area.

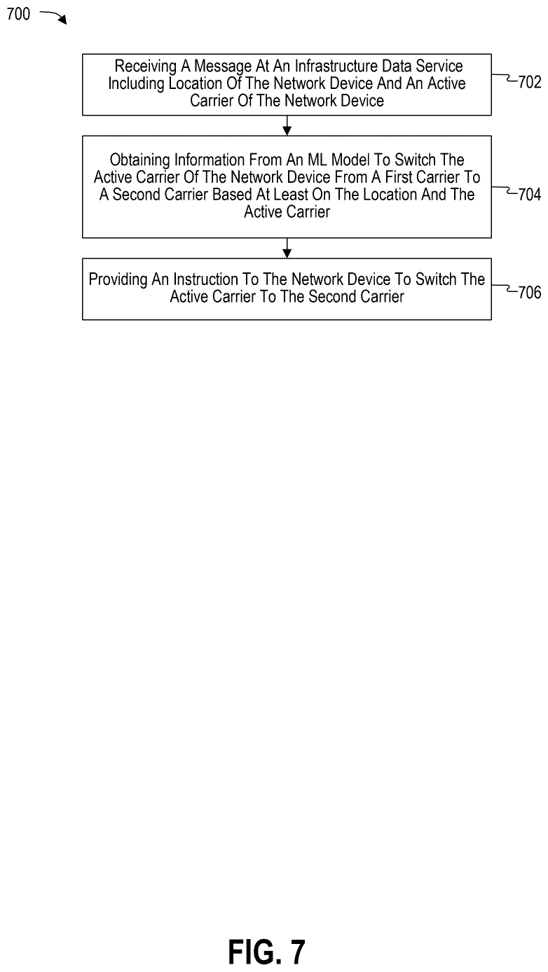

FIG. 7 illustrates an example method for federated cloud-based multi-SIM management at an IoT backend in accordance with some aspects of the disclosure. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence. Although a computing device (e.g., using the system-on-chip (SoC) or a hardware component such as an FPGA or ASIC, etc.) is described as performing the method, this example is for descriptive purposes.

At block 702, the computing device may receive, from a network device attached to a vehicle, a message. The message includes location of the network device and can include an active carrier (e.g., an MNO) of the network device. In this example, the network device includes a first SIM for a first network corresponding to the active carrier and a second SIM for a second network. The computing device is part of an infrastructure data service that is connected to the first network and the second network for SIM management of the network device. In some cases, the message can be a report related to cellular conditions and may include a plurality of geofences, which each geofence including a location (e.g., a center point) and a radius representing a signal strength associated with the active carrier.

In some cases, the message identifies a quality of service associated with an application currently providing content at the network device. For example, the message can identify particular requirements, such as latency, jitter, etc. necessary to support the application of the network device.

In some cases, computing device may request a network measurement of the first communication link from the first carrier. For example, the infrastructure data service (e.g., an IoT backend) may request network measurements at the active carrier for input into an ML model. The computing device may receive a first measurement associated with the first carrier, which can be provided by a network device (e.g., an IoT router affixed to a vehicle or location) or by the MNO. The computing device may append additional information (e.g., at least one of weather information, a timestamp, interference information, noise information, or traffic conditions, etc.) to the first measurement.

At block 704, the computing device may obtain information from an ML model to switch the active carrier of the network device from a first communication link associated with a first carrier to a second communication link associated with the second carrier based at least on the location and the active carrier. For example, the ML model may predict that a signal associated with the second carrier provides better service based on a plurality of factors. An example of a factor to determine the carrier includes a destination location or a predicted location for determining the active carrier. The destination location is known by the IoT router (e.g., a next dropoff location). A predicted location may be detected based on a statistical techniques and historical data without knowing a final destination. In another example, the ML model is configured to determine the active carrier based on the quality of service to support the application (e.g., identified in the message).

In some cases, block 704 may be based on a current billing cycle and a volume of data consumed. For example, the computing device may retrieve at least one of network data transmission pricing and network data consumption of a current billing cycle from at least the active carrier (e.g., the first carrier or the second carrier). In this case, the ML model determines the active carrier from the first carrier and the second carrier based on the network data transmission pricing and the network data consumption of the current billing cycle. For example, if the active carrier is the first carrier and bandwidth consumed in 80% of a threshold (e.g., 40GB of a 50GB data cap), the network device may determine to handover to the second MNO because the second carrier has consumed 10% of the threshold (e.g., 10GB of 50GB).

At block 706, the computing device may provide an instruction to the network device to switch the active carrier from the first carrier to the second carrier. In some cases, the instruction includes a reason code that identifies a reason for the instruction to switch to the second carrier. The reason code may be generated based on an inner monologue associated with the ML model, which can be stored and retrieved later to facilitate network operation maintenance and diagnostics.

In some cases, as part of block 706, the computing device may identify a condition based on a trajectory of the vehicle to include in the instruction, which may be included in the instruction. The network device is configured to execute the instruction based on satisfying the condition or discard the instruction if the trajectory of the vehicle changes before the condition is satisfied. The instruction provides advance notice that signal condition will deteriorate and trigger the network device to handover to a different MNO (e.g., switch from the first SIM 330 to the second sim 332).

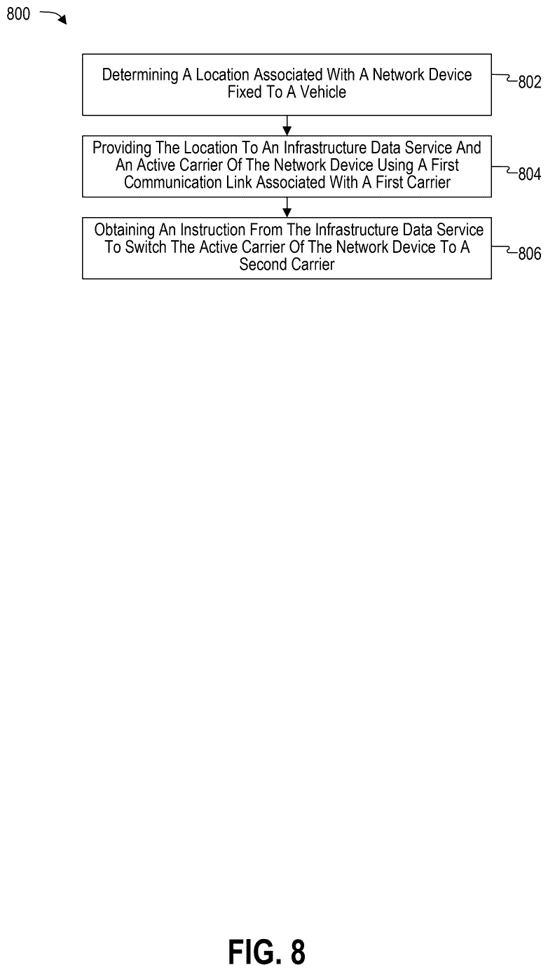

FIG. 8 illustrates an example method for federated cloud-based multi-SIM management at an IoT Router in accordance with some aspects of the disclosure. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence. Although a network device (e.g., using the system-on-chip (SoC) or a hardware component such as an FPGA or ASIC, etc.) is described as performing the method, this example is for descriptive purposes.

At block 802, the network device may determine a location of a vehicle that the network device is mounted on. For example, the

At block 804, the network device may provide the location to an infrastructure data service (e.g., the IoT backend 360 of FIG. 3 of the IoT backend 408 of FIG. 4) and an active carrier of the network device using a first communication link associated with a first carrier. For example, the network device can send a message to the infrastructure data service with the location of the vehicle. In one non-limiting example, the message may include a plurality of geofences that are modeled by a location (e.g., a center point) and a radius (e.g., corresponding to an likelihood of successful communication).

In some cases, the network device may also report a first measurement associated with a single location and a vector identifying a trajectory of the vehicle at the single location. For example, the network device provides data to facilitate operations of an ML model. The ML model predicts that a signal associated with the second carrier provides better service based on a plurality of factors. The network device or the infrastructure data service is configured to append additional information to the first measurement. Non-limiting example of the additional information comprises at least one of weather information, a timestamp, interference information, noise information, or traffic conditions.

At block 806, the computing device may obtain an instruction from the infrastructure data service to switch the active carrier of the network device from the first communication link to a second communication link associated with a second carrier. In one case, an ML model is configured to determine a handover to the second carrier without measurements of the first communication link based at least on the location and the active carrier. Conventional handover is based on measurements at the mobile device. In this case, the infrastructure data service can make the determination of when to migrate between carriers (e.g., by deactivating a first SIM and activating a second SIM). In this case, the first SIM and the second SIM are both hardware-based (e.g., not electronic SIMs) that do not require reprogramming. For example, electronic SIMs require authentication when switching between programmable SIMs, which can create significantly large delays that would be unacceptable for the network device because a duration it would be unavailable.

In some cases, the instruction includes a condition based on a trajectory of the vehicle, and the instruction is discarded if the trajectory of the vehicle changes before the condition is satisfied. A destination location or a predicted location based on the trajectory of the vehicle is provided to the ML model for determining the active carrier based on the destination location or the predicted location. For example, if the network device is a public safety vehicle, a destination may not be known and the instructions can be related to potential changes the public safety vehicle is likely to take.

In other cases, an application currently displaying content at the network device is provided to the ML model. The ML model is configured to determine the active carrier based on a quality of service to support the application. For example, the application may be one factor of the plurality of factors, or requirements of the application can be included in the plurality of factors. Other non-limiting factors include traffic conditions, destination, etc.

The ML model may determine the active carrier from the first carrier and the second carrier based on network data transmission pricing and network data consumption of a current billing cycle. The instruction (e.g., provided to the network device) may include a reason code that identifies a reason for the instruction to switch to the second carrier. The reason code may be generated based on an inner monologue associated with the ML model, which can be stored and retrieved later to facilitate network operation maintenance and diagnostics. For example, an ML model can be trained to output information corresponding to its internal state regarding how its next steps. For example, training data can be annotated with information indicating current state of a device, which can be used to then identify inflection points regarding potential changes. The annotations can help helpful to allow the ML model to find a reason and explain its current state. For example, the ML model can generate text indicating “signal strength dropped by 10 dBm within 100 m and may be headed into an area with no communication.” During inference, the ML model can output this information to help identify its actions and reasons for making decisions. These inner monologues are helpful for training, and can also be useful when developing and deploying models.

### Example System

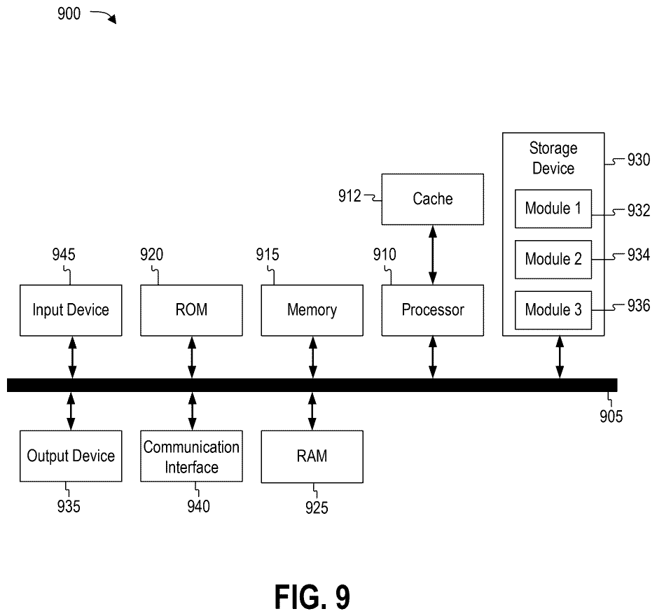

FIG. 9 is a diagram illustrating an example of a system for implementing certain aspects of the present technology. In particular, FIG. 9 illustrates an example of computing system 900, which can be for example any computing device making up an internal computing system, a remote computing system, a camera, or any component thereof in which the components of the system are in communication with each other using connection 905. Connection 905 can be a physical connection using a bus, or a direct connection to processor 910, such as in a chipset architecture. Connection 905 can also be a virtual connection, networked connection, or logical connection.

In some aspects, computing system 900 is a distributed system in which the functions described in this disclosure can be distributed within a data center, multiple data centers, a peer network, etc. In some aspects, one or more of the described system components represents many such components each performing some or all of the function for which the component is described. In some aspects, the components can be physical or virtual devices.

Example computing system 900 includes at least one processing unit (a central processing unit (CPU) or processor) such as processor 910 and connection 905 that couples various system components including system memory 915, such as ROM 920 and RAM 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Aspects of the present disclosure include the following:

In one aspect, a method of an infrastructure data service includes receiving, from a network device attached to a vehicle, a message at the infrastructure data service, the message including location of the network device and an active carrier of the network device, wherein the network device includes a first subscriber identity module (SIM) for a first network corresponding to the active carrier and a second SIM for a second network, wherein the infrastructure data service is connected to the first network and the second network for SIM management; obtaining information from a machine learning (ML) model to switch the active carrier of the network device from a first communication link associated with a first carrier to a second communication link associated with a second carrier based at least on the location and the active carrier; and providing an instruction to the network device to switch the active carrier to the second carrier.

In another aspect, the method further includes requesting a network measurement of the first communication link from the first carrier, wherein the network measurement is provided to the ML model.

In another aspect, the method further includes receiving a first measurement associated with the first carrier; and appending additional information to the first measurement, wherein the additional information comprises at least one of weather information, a timestamp, interference information, noise information, or traffic conditions.

In another aspect, the message includes a location and a radius representing a signal strength associated with the active carrier.

In another aspect, the ML model predicts that a signal associated with the second carrier provides better service based on a plurality of factors.

In another aspect, the method further includes identifying a condition based on a trajectory of the vehicle to include in the instruction, wherein the network device is configured to execute the instruction based on satisfying the condition, and wherein the instruction is discarded if the trajectory of the vehicle changes before the condition is satisfied.

In another aspect, the ML model predicts a destination location or a predicted location for determining the active carrier.

In another aspect, the message identifies a quality of service associated with an application currently providing content at the network device, and the ML model is configured to determine the active carrier based on the quality of service to support the application.

In another aspect, the method further includes retrieving at least one of network data transmission pricing and network data consumption of a current billing cycle from the first carrier and the second carrier, wherein the ML model determines the active carrier from the first carrier and the second carrier based on the network data transmission pricing and the network data consumption of the current billing cycle.

In another aspect, the instruction includes a reason code that identifies a reason for the instruction to switch to the second carrier, wherein the reason code is generated based on an inner monologue associated with the ML model.

In another aspect, a method for federated SIM management includes determining a location associated with a network device fixed to a vehicle; providing the location to an infrastructure data service and an active carrier of the network device using a first communication link associated with a first carrier; and obtaining an instruction from the infrastructure data service to switch the active carrier of the network device from the first communication link to a second communication link associated with a second carrier, wherein a machine learning (ML) model is configured to determine a handover to the second carrier without measurements of the first communication link based at least on the location and the active carrier.

In another aspect, the method further includes reporting a first measurement associated with a single location and a vector identifying a trajectory of the vehicle at the single location.

In another aspect, the network device or the infrastructure data service are configured to append additional information to the first measurement, wherein the additional information comprises at least one of weather information, a timestamp, interference information, noise information, or traffic conditions.

In another aspect, the first measurement comprises a location and a radius representing a signal strength associated with the first carrier of the second carrier.

In another aspect, the ML model predicts that a signal associated with the second carrier provides better service based on a plurality of factors.

In another aspect, the instruction includes a condition based on a trajectory of the vehicle, wherein the instruction is discarded if the trajectory of the vehicle changes before the condition is satisfied.

In another aspect, a destination location or a predicted location based on the trajectory of the vehicle is provided to the ML model for determining the active carrier based on the destination location or the predicted location.

In another aspect, an application currently displaying content at the network device is provided to the ML model, wherein the ML model is configured to determine the active carrier based on a quality of service to support the application.

In another aspect, the ML model determines the active carrier from the first carrier and the second carrier based on network data transmission pricing and network data consumption of a current billing cycle.

In another aspect, the instruction includes a reason code that identifies a reason for the instruction to switch to the second carrier, wherein the reason code is generated based on an inner monologue associated with the ML model.

### Variations and Implementations

In some examples, the processes described herein (e.g., method 700, method 800, and/or other process described herein) may be performed by a computing device or apparatus. In one example, the method 700 and the method 800 can be performed by a computing device having a computing architecture of the computing system 900 shown in FIG. 9.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, graphical processing units (GPUs), digital signal processors (DSPs), CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“”) and greater than or equal to (“”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an ASIC, FPGAs, or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

What is claimed is:

1. A method of an infrastructure data service, comprising:
receiving, from a network device attached to a vehicle, a message at the infrastructure data service, the message including location of the network device and an active carrier of the network device, wherein the network device includes a first subscriber identity module (SIM) for a first network corresponding to the active carrier and a second SIM for a second network, wherein the infrastructure data service is connected to the first network and the second network for SIM management;
obtaining information from a machine learning model to switch the active carrier of the network device from a first communication link associated with a first carrier to a second communication link associated with a second carrier based at least on the location and the active carrier; and
providing an instruction to the network device to switch the active carrier to the second carrier.

2. The method of claim 1, further comprising:
requesting a network measurement of the first communication link from the first carrier, wherein the network measurement is provided to the machine learning model.

3. The method of claim 1, further comprising:
receiving a first measurement associated with the first carrier; and
appending additional information to the first measurement, wherein the additional information comprises at least one of weather information, a timestamp, interference information, noise information, or traffic conditions.

4. The method of claim 1, wherein the message includes a location and a radius representing a signal strength associated with the active carrier.

5. The method of claim 1, wherein the machine learning model predicts that a signal associated with the second carrier provides better service based on a plurality of factors.

6. The method of claim 1, further comprising:
identifying a condition based on a trajectory of the vehicle to include in the instruction,
wherein the network device is configured to execute the instruction based on satisfying the condition, and wherein the instruction is discarded if the trajectory of the vehicle changes before the condition is satisfied.

7. The method of claim 1, wherein the machine learning model predicts a destination location or a predicted location for determining the active carrier.

8. The method of claim 1, wherein the message identifies a quality of service associated with an application currently providing content at the network device, and
wherein the machine learning model is configured to determine the active carrier based on the quality of service to support the application.

9. The method of claim 1, further comprising:
retrieving at least one of network data transmission pricing and network data consumption of a current billing cycle from the first carrier and the second carrier,
wherein the machine learning model determines the active carrier from the first carrier and the second carrier based on the network data transmission pricing and the network data consumption of the current billing cycle.

10. The method of claim 1, wherein the instruction includes a reason code that identifies a reason for the instruction to switch to the second carrier, wherein the reason code is generated based on an inner monologue associated with the machine learning model.

11. A method for federated SIM management, comprising:
determining a location associated with a network device fixed to a vehicle;
providing the location to an infrastructure data service and an active carrier of the network device using a first communication link associated with a first carrier; and
obtaining an instruction from the infrastructure data service to switch the active carrier of the network device from the first communication link to a second communication link associated with a second carrier, wherein a machine learning model is configured to determine a handover to the second carrier without measurements of the first communication link based at least on the location and the active carrier.

12. The method of claim 11, further comprising:
reporting a first measurement associated with a single location and a vector identifying a trajectory of the vehicle at the single location.

13. The method of claim 12, wherein the network device or the infrastructure data service are configured to append additional information to the first measurement, wherein the additional information comprises at least one of weather information, a timestamp, interference information, noise information, or traffic conditions.

14. The method of claim 12, wherein the first measurement comprises a location and a radius representing a signal strength associated with the first carrier of the second carrier.

15. The method of claim 11, wherein the machine learning model predicts that a signal associated with the second carrier provides better service based on a plurality of factors.

16. The method of claim 11, wherein the instruction includes a condition based on a trajectory of the vehicle, wherein the instruction is discarded if the trajectory of the vehicle changes before the condition is satisfied.

17. The method of claim 11, wherein a destination location or a predicted location based on a trajectory of the vehicle is provided to the machine learning model for determining the active carrier based on the destination location or the predicted location.

18. The method of claim 11, wherein an application currently displaying content at the network device is provided to the machine learning model, wherein the machine learning model is configured to determine the active carrier based on a quality of service to support the application.

19. The method of claim 11, wherein the machine learning model determines the active carrier from the first carrier and the second carrier based on network data transmission pricing and network data consumption of a current billing cycle.

20. The method of claim 11, wherein the instruction includes a reason code that identifies a reason for the instruction to switch to the second carrier, wherein the reason code is generated based on an inner monologue associated with the machine learning model.
